(19) United States
(12) Patent Application Publication
(10) Pub. No.: US 2008/0154723 A1
(43) Pub. Date: Jun. 26, 2008

(54) SYSTEMS AND METHODS FOR ONLINE ADVERTISING, SALES, AND INFORMATION DISTRIBUTION

(76) Inventors: James Ferguson, Tempe, AZ (US); Michael Bates, Paradise Valley, AZ (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/940,257

(22) Filed: Nov. 14, 2007

Related U.S. Application Data
(60) Provisional application No. 60/865,817, filed on Nov. 14, 2006.

(51) Int. Cl. G06Q 30/00; G06F 17/00

(52) U.S. Cl. 705/14; 705/1

(57) ABSTRACT

Systems and methods for providing online sales, advertising, and information distribution are disclosed. A user may provide a request for a mobile advertisement or other mobile content by capturing images or other content associated with items to be listed, and enter and transmit a description of the item or other associated information, typically in the form of text or a text message, to a content management system. The information is then received by the content management system and processed and stored to quickly provide displays, listings, and/or messages associated with the content, based on criteria such as item description or type, location, and price.

### CROSS-REFERENCE TO RELATED APPLICATIONS

This application claims the benefit of priority under 35 U.S.C. § 119(e) to co-pending U.S. Provisional Patent Application Ser. No. 60/865,817, entitled SYSTEMS AND METHODS FOR ONLINE ADVERTISING, SALES, AND INFORMATION DISTRIBUTION, filed Nov. 14, 2006, the contents of which is incorporated by reference herein in its entirety for all purposes.

### FIELD OF THE INVENTION

The present invention relates generally to online advertising, sales, and information distribution. More particularly but not exclusively the invention relates to systems and methods for creating, processing, and distributing online sales, advertising, and information content in a variety of formats from a variety of sources, including via mobile devices such as cell phones, as well as fixed devices such as computers.

### BACKGROUND OF THE INVENTION

A range of services and associated systems are currently available for online sales, advertising, and information distribution; however, most of the current providers exist as web sites requiring a web browser for use. Commonly known examples include providers such as Ebay and CraigsList. Posting items on these existing sites can be difficult and time consuming. The time required to create an account, get a digital camera, take pictures or create other media, download the media to a computer, post the media and text, and choose the correct listing category can be significant, and in some cases the process may take an hour or even longer.

Even users that have become adept at using existing web sites are likely to spend substantial time and effort getting their items or information posted. At the same time there has been a proliferation of cell phones and other handheld devices incorporating digital cameras and other media capture devices that allow for faster capture and download of information such as text, photographs, video clips, or other media. This has created a need for simpler and more efficient ways of capturing content and quickly creating online advertisements, sales listings, or other online information.

### SUMMARY

In typical embodiments, the present invention addresses the above described needs as well as others by providing systems and methods for allowing users to simply point and click to capture images or other media content associated with items to be listed, and then enter and send a description of the item, typically in the form of text or a text message. The information may be received by a content management and display system (also denoted herein as an iqzone system for purposes of brevity) and then processed and stored to quickly provide listings and/or messages associated with the content based on criteria such as item description or type, location, and price.

In typical embodiments, user time for posting information from start to finish can be reduced from hours to minutes, and with experienced users, to less than a minute. Users may also be provided with options to quickly review and edit listings, search for content or other information of interest, and provide alerts or messages to a variety of devices.

Systems and methods for accepting, processing, and displaying sales, advertising, and other types of information are further described in the following sections. User provided information such as advertisements, sales information, or related content may originate from a variety of different sources in a variety of formats including text as well as hybrid content. Information may then be easily added to an available information display or distribution system or may be further processed to allow for analysis, parsing, display, or distribution of information. The information may undergo one or more processing steps including intelligent processing in order to determine the best course of action to maintain the best possible user experience, while also requiring a minimum of data and time from the user.

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 is a block diagram illustrating an embodiment of a system for online advertising, sales, and information distribution in accordance with aspects of the present invention.

### DETAILED DESCRIPTION

The systems and methods disclosed herein are applicable to a wide range of applications related to input, display, storage, processing, transmission, delivery, and other aspects of sales, advertising, and information handling and processing.

For purposes of explanation, the following description is provided with reference to specific nomenclature and implementation details; however, it will be apparent to one skilled in the art that specific details described are not required in order to practice the invention, and that other embodiments in keeping within the spirit and scope of the present invention are possible and fully contemplated herein.

In general, embodiments of processes and associated systems in accordance with the present invention will include one or more modules for receiving content, such as advertisements, listings, requests, text, images, or video, or other types of content; one or more modules for processing and storing the received information, including analyzing the content, parsing the content, including parsing commands and associated parameters, storing the content, transmitting the content to other modules or systems, as well as other related functions; and one or more modules for distributing the content, such as generating and displaying the content and information associated with the content via fixed or mobile web pages, email, and/or via other fixed or mobile devices, such as in the form of SMS messages or via other forms of messaging.

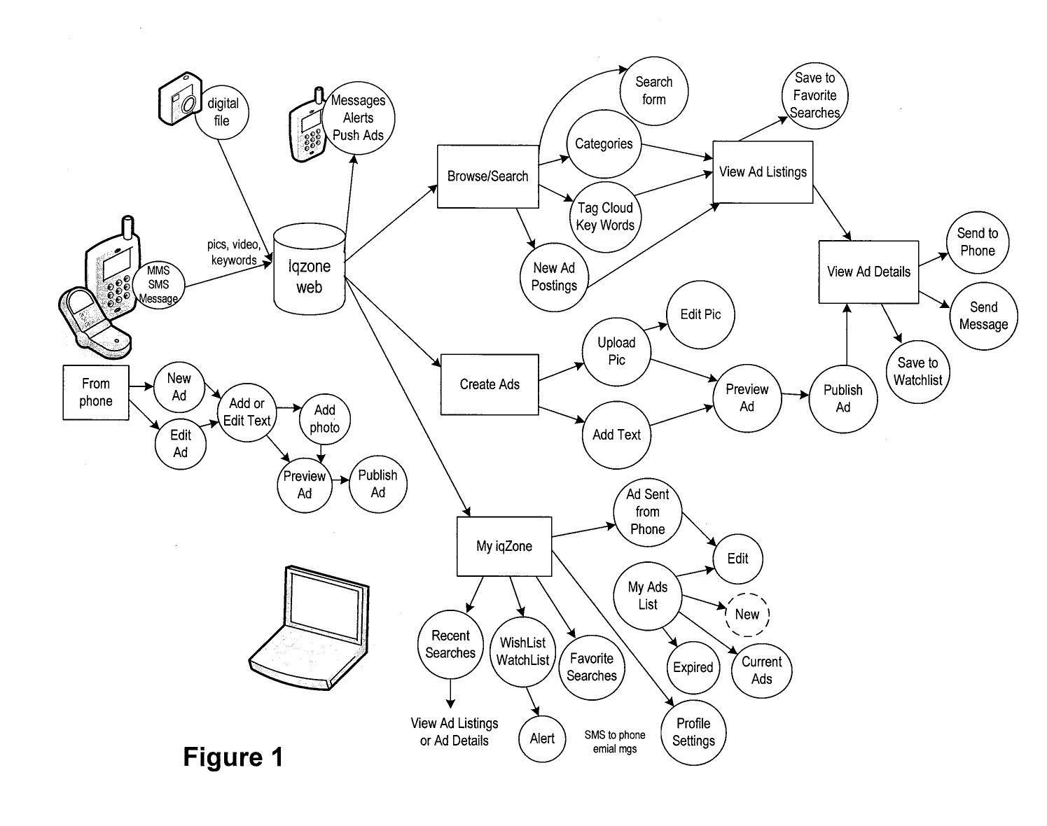

Referring now to FIG. 1, a diagram is provided of one embodiment of a system for online advertising, sales, and information distribution according to aspects of the present invention. As illustrated in FIG. 1, information can be input to the system via a variety of means including via wired or wireless computers running a web browser, as well as by mobile phones or other wired or wireless devices. Input devices may be connected to a web site or wired or wireless telecommunications provider via standard web, wired, or wireless interface methods and protocols or by other means for interfacing. A web server and associated applications, denoted as iqzone web, may be used as part of an embodiment of the invention as an interface hub and application server to run one or more application programs providing services related to sales, advertising, and information distribution. These applications and services may include, but are not limited to, Browse/Search, Create Ads, and My iqZone. Implementation and operation is described in further detail below.

### Browse/Search Features and Modules

As illustrated in FIG. 1, in some embodiments, users may access one or more Browse/Search modules wherein features related to searching, managing, and distributing information including searching for specific advertising content, accessing new ad postings, tag clouding keywords, and selection of specific categories of content are available.

Certain embodiments may include additional related modules configured for accessing or viewing advertisement listing and details. Some modules may be provided for viewing advertisement listings and may include features such as saving information or data related to advertisements in a storage module such as a favorite searches module. Some modules may be provided for viewing advertisement details and may include features such as sending data, messages, or information associated with advertisements to wired or wireless phones or handsets, sending text or voice messages, or saving information associated with advertisements to a storage module such as a watchlist.

Create Advertisements Features and Modules

As further illustrated in FIG. 1, some embodiments may include one or more Create Ads modules wherein features related to creation, storage, and publication of advertisements or other information are available. Users may access such a module to aid in inputting, processing, storing, displaying, and/or distributing information.

Some embodiments may provide one or more additional modules allowing users to upload data and information, including text, pictures, videos, audio, or other information in digital formats. For example, in one embodiment a user may be provided with an interface to create an advertisement, via a fixed or mobile device such as a computer or cell phone, capture one or more images associated with the advertisement, add text or other descriptive or related information, and then upload the advertisement to the iqzone system, where it may then be processed, analyzed, stored, parsed, displayed, and/or transmitted to other devices. Intelligent processing may be used to parse messages based on a command word set or other criteria, such as keywords, and then make intelligent decisions about the context and content of the message in order to minimize user required input and/or optimize user interaction with the system.

Some modules may be provided to further allow users to edit previously supplied information, such as editing user supplied photos, text, or other information. For example, a user may be provided with an interface to edit, update, add to, or cancel a previously supplied advertisement or other submittal and/or add content or other material to previously uploaded information. Additional modules may be provided allowing users to preview advertisements or other information prior to, concurrent with, or after publication, and some modules may be provided to further support publication of advertisements or other information on fixed or mobile web sites or via other publication sites.

Personalization Features and Modules

As further illustrated in FIG. 1, some embodiments may include one or more personalization feature modules, such as, for example, a My iqzone module. Users may access such a module to review, request, retrieve or store personalized information related to advertisements or other information either provided by the user or by other users or parties.

Certain embodiments may provide one or more modules to provide specific personalized features. For example, some modules may be provided to allow users to search or review recent searches and view or access listings or details associated with such searches. Some modules may be provided to allow users to create a WishList or WatchList wherein specific information associated with particular advertisements or other information may be stored, searched, or retrieved or may be used to generate an alert.

In some embodiments, an alert can be implemented by sending an SMS message to a wireless phone or other digital device when a triggering event occurs. Such a triggering event may be set to occur when particular user specified conditions are met, such as, for example, when an item on a WishList or WatchList is posted for sale.

Some modules may be provided to allow a user to set or store one or more Favorite Searches. For example, a Favorites Search may allow a user to specify one or more user search criteria based on particular interests or desires, with the system then searching periodically for current or new listings associated with the favorites criteria.

Some modules may be provided to allow a user to set, maintain, or update a Profile Setting, such setting including information such as user preferences or other user specific information or data. Some modules may be provided to allow users to create, set, maintain, edit, or update user specific advertisements or other information such as lists of user specific advertisements or information, or lists of user specific advertisements sent from user's phone, other mobile device, and/or web page.

In some embodiments a My Ads list module may be included to provide means for creating, accessing, editing, maintaining, processing, and distributing user specific advertisements or information. Such a module may include features for handling expired advertisements, current advertisements, edited advertisements, or new advertisements. Ad lists may include information associated with specific lists such as lists of advertisements posted, status, such as live or expired, associated with particular advertisements or other information, recently viewed advertisements, saved advertisements, or other list categories or classifications.

Content Sources

According to certain aspects of the present invention, user supplied information may be provided to various embodiments for storage, analysis, processing, display, transmission, or other purposes. Content provided may originate from a variety of sources, such as are shown in FIG. 1, including Email, SMS, MMS, FAX, Java Applets, and Web Browsers. It will be apparent to one of ordinary skill in the art that other sources of content are available and other means may be employed to provide such content, and therefore the above list is only intended to be representative, not limiting.

In certain embodiments, sources may have available functions by which a range of attributes associated with particular items, such as price, type or classification, and/or location, can be explicitly set. For example, a web browser may be used to directly set attribute values by clicking on available links, buttons, options lists, or filling in other types of data or information on input screens. In one embodiment, using a web browser such as Microsoft Internet Explorer, a user may directly select a category or location for an item to be sold from a displayed menu or options list.

In certain embodiments, sources may have limited or no available means by which specific attributes may be explicitly set. In one embodiment using, for example, a cellular telephone or other wireless handset such as a personal digital assistant (PDA), a user may be limited to sending simple text messages via a text messaging format such as SMS. Exemplary server based embodiments may be implemented to receive, process, and store information in SMS or other text based formats. Some embodiments may be further optimized to minimize associated performance parameters including minimizing text and data provided by a user by handling processing and advertisement generation at the server or other backend system elements.

In certain embodiments messages in formats such as text messages may undergo multiple processing steps, including intelligent processing, allowing users to determine the best or most relevant course of action while interacting with the system. Some embodiments may further employ intelligent processing to allow users to maintain a conversation with other users, browse posted advertisements, post and edit advertisements, forward messages, and do other operations using a text based interface.

In some embodiments received advertisements or other content may be processed automatically to set attributes, such as category of placement, location, price, and other relevant parameters.

Message Processing

Processing of incoming messages may be accomplished in a variety of ways. According to one embodiment, once a message is received it is scanned to determine whether it is a command or contains or includes command attributes. Determination of whether a message includes a command may be based on whether the message contains one or more command keywords. Command keywords may be used to indicate data or information related to inputting, formatting, storage, display, transmission, or other processing, handling, or distribution steps.

Command keywords may be allocated in a variety of ways based on the particular application. In one exemplary embodiment, command keywords may comprise one or more of the following keywords and associated parameters:

HELP [Command]; SHOW, YES, Y [Optional Message Number]; HIDE, NOSHOW [Number]; LIST, L[Optional Number of Message] [Optional User Number]; SEARCH, S [Keywords]; VIEW, V, READ, R [Message Number]; EDIT, E [Number]; SEND, MSG [User Number]; DELETE, DEL [Number]; UNDELETE, UNDEL, RECOVER [Number]; VINCHECK, VCHECK [VIN Number]; RETURN-FAX, RFAX [FAX Number]; HELP CATEGORY, HELP CAT [Number]; HELP2. In some embodiments capitalization of letters within the command keywords may be used to distinguish commands from other word usage; however, in some embodiments capitalization of specific command letters may be disregarded.

Use and operation of the above listed command keywords in one embodiment is further detailed below.
HELP [Command]—Transmitting this command prompts the system to provide detailed help on the associated Command.
SHOW, YES, y [Optional Message Number]—Posts a provided message for users to see. If Message Number is not provided, system may operate to show the last message.
HIDE, NOSHOW [Number]—Remove a message so other users cannot see it. Message can later be reshown with the SHOW command.
LIST, L [Optional Number of Messages] [Optional User Number]—List messages posted by user. If User Number is not provided then the current user's messages are listed.
SEARCH, S [Keywords]—Search messages for Keywords.
VIEW, V, READ, R [Message Number]—Read message with associated Message Number.
EDIT, E [Number]—Edit the current user's message. Additional edit keywords allowing for setting of specific attributes may be used including PRICE, DESCRIPTION, CATEGORY, and LOCATION.
SEND, MSG [User Number]—Send a message to the associated User Number. DELETE, DEL [Number]—Delete the current user's message associated with Number.
UNDELETE, UNDEL, RECOVER [Number]—Recover a recently deleted message.
VINCHECK, VCHECK [VIN Number]—Run a vehicle's Vehicle Identification Number (VIN) check.
RETURN-FAX, RFAX [FAX Number]—Return the response to the FAX Number specificed.
HELP CATEGORY, HELP CAT [Number]—List the available message categories.
HELP2—Request/Provide additional help.
REMOVE [Message Number]—Removes message associated with Message Number.

In some embodiments, command processing may also include one or more steps to determine whether a command is valid or is merely coincidentally contained in a message. Determination of command validity may be done in a variety of ways. In some embodiments context processing based on the presence of keywords in a message string in conjunction with associated text or other parameters may be used. Context processing may be used to determine whether a keyword present in a message is a command or merely an incidental part of a message. In certain embodiments a user supplied message may first be analyzed to determine whether any valid keyword commands are present. The message may then be further analyzed to determine whether there are any valid parameters associated with the keyword command. For example, the command “Remove 21” may be processed and parsed based on the command's context and associated parameters so that it may be used as a valid command to remove a user's message number 21 from the public message display. Conversely, a message including the text “Remove stains with this product” may be parsed and processed to be interpreted as an attempt to perform a non-command process such as creating a new ad, rather than as a valid command, based on the lack of associated valid command keyword parameters.

In one exemplary embodiment, a message is first analyzed to determine whether it contains a valid command keyword, in which case processing continues to determine other command parameters. If a valid command keyword exists, the text may be analyzed for command syntax. The syntax may vary from command to command and each may be analyzed individually. During this step, command parameters may be parsed out and checked for syntax.

In some messages command keywords may be either a command or a part of text of a non-command keyword message. The parameters associated with the keyword may be checked to make this determination. If it is determined that a command keyword exists but the parameters are either missing or invalid, the message may be considered to be a non-command message. For example, assume the command keyword “HIDE” can be used to remove the last message edited by the user. A message containing the text “HIDE 2323” could be sent by a user to remove message number 2323. Further, since the word “Hide” could also be part of a valid sentence, the rest of the text may be checked for parameters related to the keyword to determine if “Hide” is being used as a command keyword or is merely a word in a text string used as part of the message content. For example, a message containing the text “Hide those cables using our cable ties for $0.99” may correct fail the command keyword check and the system may then post the text string as an advertisement.

If, however, the context of the message indicates that it does not contain a command keyword, and the command keyword could not reasonably be part of the beginning of a non-command (such as “E #22” for example) then the command processing may be terminated and the user notified and sent a message so that they may clarify and/or correct the command and send it again.

If the syntax is valid, further processing may continue. During the next step of processing, the parameters may be further checked for validity and/or security access. For example, a properly formatted command to send a message to a user that doesn't exist may be captured and the user may be notified that the command could not be processed. As another example, an attempt to edit a message to which the user does not have appropriate access privileges may be caught and the user notified.

Intelligently Determining State

In some embodiments, text based messaging, such as SMS, may be used. SMS messages may be stateless, so in certain embodiments it is desirable to determine the context in which a command or commands are being executed. For example, if a message contains “SEND Yes I accept your offer for $5,” the message may be parsed and processed so that it is interpreted as a reply to a message received from another user based on a listed item. In some embodiment each conversation thread may be tracked separately so that several simultaneous conversations can occur in unison. In certain embodiments one or more of the following provisions may be used to determine the context and routing of a message to the correct conversational thread.

1. In some embodiments, one or more servers may be used that have the capacity of assigning each thread a unique server ID embedded in the original message. The server ID may be embedded as part of the originating address, subject, body, or other section. Messages sent to this unique server ID may be assigned to the thread that the associated server ID was created for. For example, if user #1 initiates a text SMS conversation with user #2, a unique server ID may be created. Responses from both users may go through the server and each message may be checked for the unique server ID. The server may then determines that the ID refers to a text conversation between users #1 and #2 and correctly routes the messages back and forth between each. In this manner, user #1 can have several simultaneous conversations with multiple users, with the associated messages getting routed to the correct conversation automatically based on server ID. This method may also be used in conjunction with other items that have an associated state, such as for managing individual messages and associated threads where several messages are posted.

2. In some embodiments, if the device is sharing one server ID for all conversations, the conversation thread may be determined by an associated text message. If the text message contains a command keyword for send or reply, then the server determines that it should be processed as a conversation between two users. In one embodiment the last known conversation may be used as a default. In some embodiments the user may override this at any time by including the user ID he wishes to converse with and that user ID will be used until overridden. In some embodiments this approach may be applied to editing messages, where the last posted message will receive the edits unless the user overrides the message being edited by passing a message ID to edit.

3. In some embodiments the context is determined by the type of device being used. For example, if user #1 has a conversation going with another user on his cell phone sending text messages, that context may be tracked separately from another conversation he may be having with the same or another user via email. User #1's email messages may be intelligently routed to the appropriate conversation or command context such as, for example, editing a message based on the last user ID or message ID being used. This context may be tracked separately for each device and email address the user accesses.

Create Ad—Parse Attributes

In some embodiments a user may request creation of a new advertisement via a message. If the message received is a request to post an advertisement, then message attributes may be parsed out. Message attributes can be explicitly set, for example, using a location attribute such as “location: phoenix, az 85283.” Message attributes which are explicitly set using keywords may be parsed and saved and the text may be removed from the final message.

In some embodiments the message attributes may be displayed, but in certain embodiments removing them from the message text may be done to clean up any clutter and prevent the attribute from being redundantly displayed. For example, a message containing information such as “Selling dx-06 ham-radio loc: 85282 price: 89.99 cat: electronics” may be parsed out based on parameters such as the location, price and category. The body of the message may then be truncated to a smaller message or text string such as “Selling dx-06 ham-radio.” Parsing out attributes may be used for a variety of purposes, including allowing other users to search by specific attributes, such as price, location, description, or category.

In some embodiments use of keywords may be optional. For instance, sending the message “Selling dx-06 ham radio for $89.99. It can be picked up in Phoenix, Ariz. 85283” will have the same attributes intelligently parsed out. In this example, the body of the text may be left unaltered as the items being parsed out may be (as in this example) part of a sentence, and removing the text may garble the message, leaving it less intelligible.

Create Ad—Parse Category

In some embodiments, correctly setting the category may be important for providing the best user experience. If there are too many messages in a general category, searching and finding specific types of items may be less successful due to spurious search results. In addition, it may be desirable for users to simply post messages without having to memorize category names or IDs. When the category isn't explicitly set, messages may be processed in order to determine the correct category.

Message processing to determine the correct category or categories may be done in a variety of ways. In some embodiments the message may be scanned against an extensive list of keywords. Each keyword may be weighted, as some keywords may be more indicative of a category than others. Also, some keywords may be used to indicate multiple categories, each with its own specific weight. For example, “Club” may indicate baseball with a weight of 100, golf with a weight of 100, and auto (for the steering wheel club) with a weight of 50. When a given message is processed, all keywords may be checked and the associated weighting values may be totaled. Each keyword may also be set to be used each time or only a certain number of times, such as X times. For instance, “Club” can be set to add it's weight every time “club” appears in the message, or only the first 2-3 times.

Additionally, keywords can be assigned a negative weight. If, for example, tennis ads contained many of the same keywords as baseball ads but it is determined that the word “club” would rarely appear in a tennis ad, the keyword “club” could be used or weighted to indicate that Tennis not be used unless it had an overwhelming number of matching keywords (or processing could be set to not use Tennis at all, irrespective of the number of matching Tennis keywords).

In some embodiments the message may then be scanned against a selection of category names. Each category name may be assigned a weight, which can be set in a variety of ways based on relevance and priority. For example, in some embodiments weighting can be set to a fixed range of values, starting at 0 (zero) when it is desired that a particular category name not be used.

Similar to keywords, category names may be assigned a number indicating how many times they can be weighted in the same message. In some embodiments, category name can also be optionally assigned a price range as well as a positive price weight and a negative price weight. For example, a car category “Audi” may be assigned a price range of $5,000-$50,000. If a message price is outside of this range, it will be negatively weighted. In another example, someone selling an Audi Battery, which may be assigned to a category such as parts or car parts, might be listed or offered for sale for $50. Since it falls outside the price range, the Audi car category may be negatively weighted, while the parts sub-category may be positively weighted for this price.

In some embodiments, categories may be associated with child categories, and category names may give a percentage of their weight to any associated child categories. For example, if a message includes the word Audi, the category “Audi” may receive the value of, for example, 100, while it's child categories would receive a percentage of that value. For example, Audi/4000 and Audi/5000 might receive a value of 100 each. When processing is complete, each category total may then be checked. If there are ties in total value between multiple categories a category prioritization process may be used. In some embodiments, each category may be assigned a priority which may be used to break ties. In certain embodiments, when a tie occurs, the user may be presented with an option to select one of the tying categories, and the priority may be used to set the default choice.

In some embodiments, the category with the highest value may then be checked to see if it has any child categories. In certain embodiments, messages may be processed to drill down to the furthest possible level in the child or subcategories. The child category with the highest weight may then be selected. The child categories may then be checked themselves and the process repeated until no additional level of categorization is available.

In certain embodiments, if the highest value has more than one child category at a tie, then the parent category may be used. As one possible example of this process, assume a message includes the language “AUDI for sale $12000.” Further assume that category AUDI would be assigned a value of 100 and it's child categories would all be assigned a value of 50. At the completion of processing the category AUDI would be selected, because all of the child categories were assigned the same value under the parent category AUDI. In another example using the message “AUDI 4000 for sale,” where a child category “AUDI/4000” was defined, the “AUDI/4000” child category, rather than the “AUDI” parent category, could be assigned based on it's more specific textual parameters.

Create Ad—Future Post

In some embodiments users have the option of customizing message posting. Each user may customize how messages are posted based on device or type of device they use. Predefined default formatting may also be used. For example, a default format may be predefined for cell phone messages. By default, cell phone messages may be set to “future post in 5 minutes.” After a user sends his advertisement or other information, the message is processed and various attributes parsed.

A confirmation message may then be sent back to the user asking if the message is ok to post and informing the user that if no action is taken, the message will be posted in 5 minutes. The user may then be allowed to revise the message. If any revisions to the message are made, the 5 minute timer may then be restarted. In certain embodiments the user may reply to the confirmation message with a keyword command, such as those described previously. For example, a user may reply with “N, NO, NOSHOW or HIDE” to prevent the message from being posted. The message may then be saved in the user's custom message store where it may later be available to be edited and/or posted at the user's convenience.

By using features such as ‘future post’ and/or intelligent parsing, most users will be able to send a single SMS message and have their ad posted, minimizing needless confirmation messages from the user. ‘Future post’ may also be used to allow the user to edit or stop the message from being posted, maintaining the integrity of advertisements being placed.

Custom Conversion and Delivery of Ad Content

In some embodiments users may include attachments with incoming messages. The system may process and scan attachments based on their type or context. In certain embodiments, each incoming message may be scanned for attachments and saved. The most common conversions may be processed in advance and cached. When a message is being viewed, the attachments may be converted as needed for the device requesting the message. For example, if a user sends a message from their phone containing a video file and a spreadsheet file, it will be converted to the appropriate format when the message is retrieved from another device. Media may be converted from one format to another based on a variety of parameters including format, height, width, color depth, data size, or other attributes.

Custom Message Routing

In some embodiments users may set up custom delivery rules. A user may specify time ranges and rules for receiving messages which are routed to the user's devices. For example, a user may specify that all messages he receives be delivered to his cell phone during the daytime, his email at night, and his fax machine in the very early morning. Additionally, the user may specify custom delivery rules based on device, watchlist, and advertisements he places. For example, he may specify that messages that are being sent to his email are not re-routed, but messages to his cell phone late at night are routed to his fax and email. Message routing may also be specified by advertisement. For example, if the user places an advertisement selling a book and his car, he may specify that responses to the car advertisement are immediately routed to his cell phone, while messages regarding the book are routed to email.

It is noted that in various embodiments aspects of the present invention relate to processes such as are described and illustrated herein. These processes are typically implemented in one or more modules comprising systems as described herein, and such modules typically including computer software stored on a computer readable medium including instructions configured to be executed by one or more processors. It is noted that, while the processes described and illustrated herein may include particular process steps or stages, it is apparent that other processes including fewer, more, or different stages than those described and shown are also within the spirit and scope of the present invention. Accordingly, the processes shown herein are provided for purposes of illustration, not limitation.

It is further noted that some embodiments of the present invention may include computer software and/or computer hardware/software combinations configured to implement one or more processes or functions associated with the present invention. These embodiments may be in the form of modules implementing functionality such as has been described previously in software, hardware, and/or hardware software combinations. Modules may comprise instructions stored on a computer readable medium and configured to be executed on one or more processors on one or more systems.

Embodiments may also take the form of a computer storage product with a computer-readable medium having computer code thereon for performing various computer-implemented operations, such as operations related to functionality as described herein. The media and computer code may be those specially designed and constructed for the purposes of the present invention, or they may be of the kind well known and available to those having skill in the computer software arts, or they may be a combination of both.

Examples of computer-readable media within the spirit and scope of the present invention include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices.

Examples of software or computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using assembly language, Java, C, C#, C++, or other programming languages and software development tools as are known in the art. Other embodiments of the invention may be implemented in whole or in part with hardwired circuitry in place of, or in combination with, machine-executable software instructions.

The foregoing description, for purposes of explanation, used specific nomenclature to provide a thorough understanding of embodiments of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

I claim:

1. A system for providing content in an online format, comprising:
a content reception module configured to receive content from ones of a plurality of mobile devices;
a content processing module configured to analyze and store, responsive to said analyzing, the received content; and
a content distribution module configured to distribute the stored content via one or more distribution networks.

2. The system of claim 1 wherein the content comprises information related to an advertisement for goods or services, the advertisement generated at least in part in conjunction with a first of the plurality of mobile devices.

3. The system of claim 2 wherein the content further includes text and one or more images associated with the advertisement, said image captured by the mobile device.

4. The system of claim 2 wherein the content includes a description associated with the advertisement, said description including a sales price or sales price range.

5. The system of claim 3 wherein the content reception module is configured to receive the content in conjunction with an SMS message.

6. The system of claim 1 further comprising a content search module configured to receive, from a user, user input associated with a content search criteria;
search the stored content for relevant content; and generate a search result related to said content search criteria.

7. The system of claim 6 wherein the content distribution module provides the search result to one or more displays.

8. The system of claim 6 wherein the search result is provided to a mobile device, associated with the user, as an alert.

9. The system of claim 8 wherein the alert is associated with an SMS message.

10. The system of claim 1 wherein the content processing module comprises a command processing module disposed to process command input provided by a first of said plurality of mobile devices, said command input including one or more predefined command keywords and associated keyword parameters.

11. The system of claim 10 wherein said processing includes parsing the command keyword and associated keyword parameters, and responding to the command input based at least in part on said parsing.

12. The system of claim 11 wherein said responding includes determining whether the command input is valid based at least in part on said keyword syntax and said keyword parameters.

13. The system of claim 12 wherein said responding further comprises:
determining, based on said keyword, whether said command input is a request for an advertisement; and
based on said determining, posting said advertisement.

14. The system of claim 13 wherein said posting said advertisement further includes:
analyzing said command input to determine an association between the content of said command input and a set of predefined categories; and
associating said advertisement with one or more of said predefined categories.

15. A method for providing content in an online format, comprising:
receiving content from a mobile device;
processing the content based on a set of predefined commands; and
responsive to said processing, distributing the content.

16. The method of claim 15, wherein said processing the content includes:
searching the content for one or more keywords consistent with a predefined set of keywords;
responsive to said searching, determining whether said keywords are associated with one or more keyword parameters; and
based on said determining, storing said keywords and said keyword parameters.

17. The method of claim 16, wherein said distributing the content includes
determining, based on said stored keywords and keyword parameters, one or more response actions, said response actions including posting an advertisement, removing an advertisement, providing a listing of content, providing a help menu, and providing an error message.

18. A method of providing advertisements in a mobile content delivery system, comprising:
receiving, at a content management system, a message related to a request for an advertisement, the message including one or more predefined keywords;
parsing the message to identify the one or more keywords;
weighting, based on a predefined weighting criteria associated with each of a plurality of categories, one or more of the one or more keywords;
summing, for each category, the associated keyword weights; and
storing, based on said summing, a set of categories and associated category weights.

19. The method of claim 18 further comprising choosing, from said set of categories, one or more selected categories to associate with the requested advertisement.

20. The method of claim 19 further comprising distributing said advertisement in association with said one or more selected categories.
